(19) United States
(12) Patent Application Publication
(10) Pub. No.: US 2021/0282387 A1
(43) Pub. Date: Sep. 16, 2021

(54) Pet Deterrent Device

(71) Applicant: Shanna Clemmons, San Angelo, TX (US)

(72) Inventor: Shanna Clemmons, San Angelo, TX (US)

(21) Appl. No.: 16/921,378

(22) Filed: Jul. 6, 2020

Related U.S. Application Data
(60) Provisional application No. 62/989,849, filed on Mar. 15, 2020.

(51) Int. Cl. A01M 29/18; A01K 15/02; G08B 5/36

(52) U.S. Cl. CPC A01M 29/18; H04R 3/00; G08B 5/36; A01K 15/021

(57) ABSTRACT

A deterrent device for training a pet to avoid a specific area. The deterrent device is a motion detection activated ultrasonic device that utilizes a high frequency sound to deter cats, dogs, and other pets from entering a protected area. The deterrent device comprises an ultrasonic transducer activated by a motion detector. Once motion is detected, the ultrasonic transducer emits ultrasound at a frequency of between 35-45 kHz to repel an animal from a protected area such as, a countertop, furniture, or a room. A frequency adjustment component allows a user to adjust the frequency based on the specific animal to be deterred. The deterrent device may be powered by alternating current or by battery.

### CROSS-REFERENCE TO RELATED APPLICATION

The present application claims priority to, and the benefit of, U.S. Provisional Application No. 62/989,849, which was filed on Mar. 15, 2020 and is incorporated herein by reference in its entirety.

### BACKGROUND

The present invention generally relates to pet training, and more specifically to a pet deterrent device for training an animal to stay away from a particular area. Accordingly, the present specification makes specific reference thereto. However, it is to be appreciated that aspects of the present invention are also equally amenable to other like applications, devices and methods of manufacture.

Teaching pets to avoid certain areas in a home can be a time consuming and laborious task. Many pet owners would like to deter their pet from specific places, such as on a couch, a countertop, near a trashcan, etc. Trying to enforce these rules is difficult and requires a lot of day-to-day training that is not always possible. There are many reasons that it is desirable or necessary to keep pets away from certain areas. For example, pets all too frequently tamper with holiday décor, such as Christmas trees, ornaments, gifts, etc. Keeping an animal away from holiday items can be a never ending task. In addition, animals can chew household items or ingest hazardous garbage. Furniture and other household items and decor can easily be destroyed by a pet. Without a training aid, pets may escape through open doors or jump on visiting guests. An effective training means is necessary.

There are many different devices and techniques for training pets. Many of them require substantial owner involvement and constant attention. Positive reinforcement uses a reward system to provide the pet a reward when positive behavior is observed. Positive punishment uses a negative action when the animal behaves inappropriately. Similarly, negative punishment and negative reinforcement techniques are often used. Other techniques include using devices like clickers or shock collars to reinforce proper behavior. A favorite food or pet treat can be used as positive reinforcement as well. Conversely, repellents typically work as negative reinforcement by taking advantage of an animal's natural aversion to something, such as noises, odors, taste, or fear.

Ultrasound is sound waves with frequencies higher than the upper audible limit of human hearing. Ultrasound is not different from “normal” (audible) sound in its physical properties, except that humans cannot hear it. This limit varies from person to person and is approximately 20 kilohertz (20,000 hertz) in healthy young adults. Ultrasound devices operate with frequencies from 20 kHz up to several gigahertz.

Ultrasonic devices operate through emitting short wavelength, high frequency sound waves that are too high in pitch to be heard by the human ear, generally accepted to be frequencies greater than 20 kHz. Humans are usually unable to hear sounds higher than 20 kHz due to physiological limitations of the cochlea, though there is considerable variation between individuals, especially at such high frequencies. Some animals, such as cats, dogs, and rodents, can hear well into the ultrasonic range.

Dogs and cats' hearing range extends well into the ultrasound frequency. The top end of a typical dog's hearing range is about 45 kHz, while a typical cat's is 64 kHz. The wild ancestors of cats and dogs evolved this higher hearing range to hear high-frequency sounds made by their preferred prey, small rodents. A dog whistle is a whistle that emits ultrasound, used for training and calling dogs. The frequency of most dog whistles is within the range of 23 to 54 kHz.

Ultrasound devices have been used to train dogs for years. Typical systems use a collar worn by the dog and a separate device that emits a high-pitched sound from the device or collar when activated. When the dog barks, the owner activates the device and the sound is emitted to discourage further barking. While this may be effective, it requires the owner to be present and actively participate in the aversion training. This would not work without active human participation. Additionally, while there are products like this for dogs, there are no similar devices for other pets such as cats.

In this manner, the improved pet deterrent device of the present invention accomplishes all of the forgoing objectives, thereby providing an easy solution to keep their pets safe. A primary feature of the present invention is that it provides pet owners, groomers, veterinarians, and pet sitters with a device to assist in training pets to deter them from entering a specific area. The device enables users to keep cats and dogs off of furniture or out of a specific room or area of a house. The device protects pets from hazardous situations by preventing them from accessing high risk areas, such as a garbage can or a garage. Finally, the improved of the present invention is capable of allowing users to gently, safely, and easily train an animal to avoid certain areas without causing harm to the pet.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some concepts in a simplified form as a prelude to the more detailed description that is presented later.

The subject matter disclosed and claimed herein, in one embodiment thereof, comprises a deterrent device. The deterrent device is for use in protecting a designated space from incursion by a pet. The deterrent device comprises an ultrasonic transducer and a motion detection component retained in a housing. The ultrasonic transducer is configured to emit an ultrasonic burst of sound. The ultrasonic transducer is activated to emit the ultrasonic burst via the motion detection component. A frequency of the ultrasonic burst of sound is selectable via a frequency adjusting component. A plurality of predetermined frequencies are selectable typically from a frequency range of between approximately 35 kHz to approximately 45 kHz.

The ultrasonic burst of sound is may be emitted for a predetermined amount of time or may be continuously emitted for as long as motion is detected by the motion detecting component. The deterrent device is battery powered and may be rechargeable. The deterrent device may further comprise an indicator light. The indicator light can indicate when the deterrent device is powered on or when the deterrent device is emitting an ultrasonic burst. The deterrent device may further comprise a nightlight.

In an additional embodiment, a deterrent device comprises an ultrasonic transducer and a motion detection component retained in a housing. The ultrasonic transducer is configured to emit an ultrasonic burst of sound. The ultrasonic transducer is activated to emit the ultrasonic burst via the motion detection component. A frequency of the ultrasonic burst of sound is selectable via a frequency adjusting component. A plurality of predetermined frequencies are selectable from a frequency range of between approximately 35 kHz to approximately 45 kHz.

The ultrasonic burst of sound is may be emitted for a predetermined amount of time or may be continuously emitted for as long as motion is detected by the motion detecting component. The deterrent device is powered via alternating current. The deterrent device may further comprise a battery backup. The deterrent device may further comprise an indicator light. The indicator light can indicate when the deterrent device is powered on or when the deterrent device is emitting an ultrasonic burst. The deterrent device may further comprise a nightlight.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and is intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one embodiment of a deterrent device of the present invention for ultrasonically training a pet to avoid a protected area in accordance with the disclosed architecture.

FIG. 2 illustrates a close-up partial perspective view of the deterrent device of the present invention for ultrasonically training the pet to avoid the protected area in accordance with the disclosed architecture.

FIG. 3 illustrates an overhead view of an inside of the deterrent device of the present invention for ultrasonically training the pet to avoid the protected area in accordance with the disclosed architecture.

FIG. 4 illustrates a perspective view of the deterrent device of the present invention for ultrasonically training the pet to avoid the protected area in accordance with the disclosed architecture.

FIG. 5 illustrates a perspective view of the deterrent device of the present invention ultrasonically deterring a pet from entering the protected area in accordance with the disclosed architecture.

FIG. 6 illustrates an overhead view of an inside of another embodiment of a deterrent device of the present invention for ultrasonically training the pet to avoid the protected area in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They do not intend as an exhaustive description of the invention or do not limit the scope of the invention. Additionally, an illustrated embodiment need not have all the aspects or advantages shown. Thus, in other embodiments, any of the features described herein from different embodiments may be combined.

The present invention, in one exemplary embodiment, is a motion detection activated ultrasonic infrared device that utilizes high frequency sound to deter cats and dogs from entering a protected area. Passive infrared motion detectors detect emitted infrared energy which is given off by animals in the form of heat. The sensor in turn signals a control box which may be programmed to emit an ultrasonic sound out of the range of human hearing. The device is designed to deter pets from entering specific areas of a home, grooming salon, office, etc. The device may be a small lightweight disc or cylinder using ABS plastic or a sturdy recycled plastic with a motion detector activated high frequency sound device inside. The device will have an on/off switch with an indicator light and may be rechargeable with a battery backup. The device may employ a small nightlight that automatically illuminates in the dark. The device is focused on motion detection and sound for animal training purposes. The high frequency sound options may include 35-45 kHz, with low being 35 kHz, medium being 40 kHz, and high being 45 kHz. The device may be shaped like an animal paw or any other relevant or desired design.

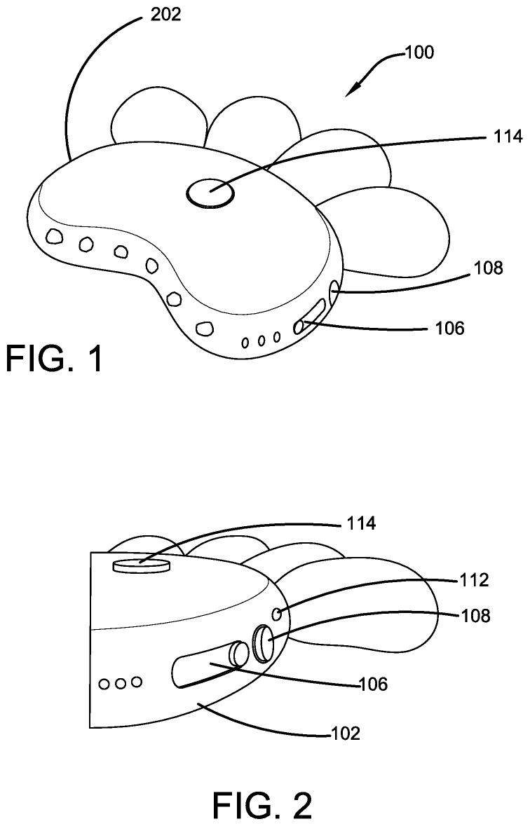

Referring initially to the drawings, FIGS. 1-5 illustrate a deterrent device 100. The deterrent device 100 is for use in protecting a designated space from incursion by a pet or domesticated animal. The protected space may be any area in which the user wants to keep the away. For example, the deterrent device 100 may be placed on a kitchen counter, a piece of furniture, or in a room that the user wants to keep the pet off or away from. The range of the deterrent device 100 will be dependent on the physical characteristics of the area to be protected but may be at least six feet or more.

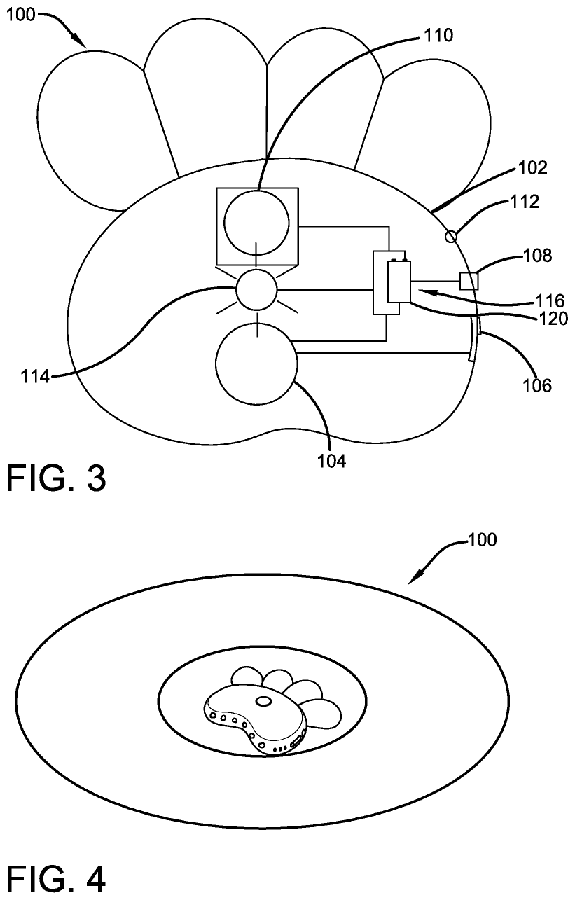

As illustrated in FIG. 3 the deterrent device 100 comprises an ultrasonic transducer 104 and a motion detection component 110 retained in a housing 102. The ultrasonic transducer 104 may be a piezoelectric transducer that generates ultrasonic activity to measure the pressure of sound waves that are above frequencies detectable by the human ear. The piezoelectric transducer functions by rapidly expanding and contracting when appropriate electrical frequency and voltage is applied. As illustrated in FIG. 1, the housing 102 may be shaped as a disc, cylinder, an animal paw, or any desired shape. The housing 102 is typically manufactured from ABS or recycled plastic, although any other suitable material may be used. The housing 102 is constructed so that ultrasound bursts may be emitted. For example, the housing 102 may have slits, holes, or similar openings that will allow sound transmission to pass out of an inside of the housing 102.

The ultrasonic transducer 104 is configured to emit an ultrasonic burst of sound. The ultrasonic transducer 104 is activated to emit the ultrasonic burst via the motion detection component 110. When motion is detected, such as when the pet approached the deterrent device 100, the ultrasonic transducer 104 is triggered to emit the ultrasonic burst. The motion detection component 110 may be set to detect motion based on the particular space to be protected as illustrated in FIG. 4. Thus, when the pet enters the protected area, the passive infrared motion detector or sensor will activate the piezoelectric ultrasonic transducer to emit the ultrasonic sound. Alternatively, the ultrasonic transducer 104 may be triggered manually by a user.

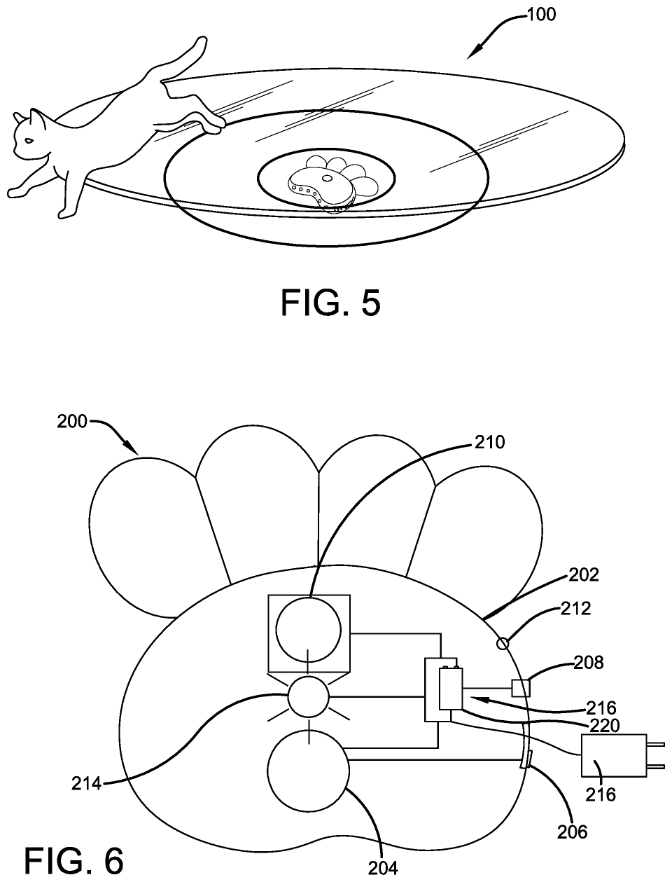

The deterrent device 100 further comprises a frequency adjusting component 106. The ultrasonic transducer 104 is configured to emit an ultrasonic burst in a frequency range. The frequency range is selectable via the frequency adjusting component 106 from a plurality of predetermined frequencies. The frequency range is typically between approximately 35 kHz to approximately 45 kHz but may be higher or lower depending on the animal as long as it is in the ultrasound range of 20 kHz up to several gigahertz and within the detectable range of the pet. In one example, the plurality of predetermined frequencies can be approximately 35 kHz, 40 kHz, and 45 kHz representing a low, medium, and high frequency option. This is desirable as different pets may respond differently to different frequencies or may develop a tolerance to a certain frequency over time. The ultrasonic burst of sound may be emitted for a predetermined amount of time when motion is detected or may be continuously emitted for as long as motion is detected by the motion detecting component. As illustrated in FIG. 5, the pet is deterred by the ultrasonic burst as the pet approached the deterrent device 100 and rapidly leaves the affected area.

As illustrated in FIG. 2, the deterrent device 100 further comprises an activation switch 108 for turning the deterrent device 100 on and off. An indicator light 112 can indicate when the deterrent device 100 is powered on. Additionally, the indicator light may indicate when the deterrent device 100 is emitting an ultrasonic burst or to indicate battery life. The deterrent device 100 may further comprise a nightlight 114. The nightlight 114 would illuminate automatically in the dark. The deterrent device 100 further comprises a power source 116. Th power source 116 is typically a battery 120. The battery 120 may be rechargeable.

In an additional embodiment as illustrated in FIG. 6, a deterrent device 200 for protecting a designated space from a pet comprises an ultrasonic transducer 204 and a motion detection component 210 retained in a housing 202. The housing 102 may be shaped as a disc, cylinder, an animal paw, or any desired shape as in the previous embodiments. The housing 202 is constructed so that ultrasound bursts may be emitted. For example, the housing 202 may have slits, holes, or similar openings that will allow sound transmission to pass out of an inside of the housing 202.

The ultrasonic transducer 204 is configured to emit an ultrasonic burst of sound. The ultrasonic transducer 204 is activated to emit the ultrasonic burst via the motion detection component 210. When motion is detected, such as when the pet approached the deterrent device 200, the ultrasonic transducer 204 emits the ultrasonic burst. The motion detection component 210 may be set to detect motion based on the particular space to be protected. Alternatively, the ultrasonic transducer 104 may be triggered manually by a user.

The deterrent device 200 further comprises a frequency adjusting component 206. The ultrasonic transducer 204 is configured to emit an ultrasonic burst in a frequency range. The frequency range is selectable via the frequency adjusting component 206 from a plurality of predetermined frequencies. The frequency range is typically between approximately 35 kHz to approximately 45 kHz, but may be higher or lower depending on the animal. In one example, the plurality of predetermined frequencies can be approximately 35 kHz, 40 kHz, and 45 kHz representing a low, medium, and high frequency option. This is desirable as different pets may respond differently to different frequencies or may develop a tolerance to a certain frequency over time. The ultrasonic burst of sound may be emitted for a predetermined amount of time when motion is detected or may be continuously emitted for as long as motion is detected by the motion detecting component.

The deterrent device 200 further comprises an activation switch 208 for turning the deterrent device 200 on and off. An indicator light 212 can indicate when the deterrent device 200 is powered on. Additionally, the indicator light may indicate when the deterrent device 200 is emitting an ultrasonic burst. The deterrent device 200 may further comprise a nightlight 214. The nightlight 214 would illuminate automatically in the dark. The deterrent device 200 further comprises a power source 116. The power source 116 is typically a power cord 218 for connecting the deterrent device 200 to an alternating current source of power. The power source 116 may further comprise a battery backup 220 that may be rechargeable.

It is contemplated that the deterrent device 100, 200 constructed in accordance with the present invention will be tailored and adjusted by those of ordinary skill in the art to accommodate various levels of performance demand imparted during actual use. Accordingly, while this invention has been described by reference to certain specific embodiments and examples, it will be understood that this invention is capable of further modifications. This application is, therefore, intended to cover any variations, uses or adaptations of the invention following the general principles thereof, and including such departures from the present disclosure as come within known or customary practice in the art to which this invention pertains and fall within the limits of the appended claims.

Notwithstanding the forgoing, the deterrent device 100, 200 of the present invention and its various structural components can be of any suitable size, shape, and configuration as is known in the art without affecting the overall concept of the invention, provided that it accomplishes the above stated objectives. One of ordinary skill in the art will appreciate that the shape and size of the deterrent device 100, 200 and its various components and material, as shown in the FIGS. are for illustrative purposes only, and that many other shapes and sizes of the deterrent device 100, 200 are well within the scope of the present disclosure. Although the dimensions of the deterrent device 100, 200 are important design parameters for attaining the deterrent device 100, 200, the deterrent device 100, 200 and its components may be of any shape or size that ensures optimal performance during use and/or that suits user need and/or preference.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A deterrent device comprising:
an ultrasonic transducer;
a frequency adjusting component for selecting a frequency for the ultrasonic transducer; and
a motion detection component for activating the ultrasonic transducer.

2. The deterrent device of claim 1, wherein the ultrasonic transducer is configured to emit an ultrasonic burst in a frequency range selectable from a plurality of predetermined frequencies.

3. The deterrent device of claim 1, wherein the ultrasonic transducer is configured to emit an ultrasonic burst in a frequency range of between approximately 35 kHz to approximately 45 kHz.

4. The deterrent device of claim 1, wherein an ultrasonic burst is emitted from the ultrasonic transducer for a predetermined time when motion is detected.

5. The deterrent device of claim 1, wherein an ultrasonic burst is continuously emitted from the ultrasonic transducer for as long as motion is detected.

6. The deterrent device of claim 1 further comprising an indicator light for indicating when the deterrent device is powered.

7. The deterrent device of claim 1 further comprising an indicator light for indicating when the deterrent device is emitting an ultrasonic burst.

8. The deterrent device of claim 1 further comprising a nightlight.

9. The deterrent device of claim 1, wherein the ultrasonic transducer is manually activatable.

10. A deterrent device comprising:
an ultrasonic transducer;
a frequency adjusting component for selecting a frequency for the ultrasonic transducer;
a motion detection component for activating the ultrasonic transducer; and
wherein the deterrent device is battery powered.

11. The deterrent device of claim 10, wherein the deterrent device is rechargeable.

12. The deterrent device of claim 10, wherein the ultrasonic transducer is configured to emit an ultrasonic burst in a frequency range of between approximately 35 kHz to approximately 45 kHz.

13. The deterrent device of claim 12, wherein the frequency of the ultrasonic burst is selectable from a plurality of predetermined frequencies.

14. The deterrent device of claim 13, wherein the plurality of predetermined frequencies are 35 kHz, 40 kHz, and 45 kHz.

15. The deterrent device of claim 10, wherein an ultrasonic burst is emitted from the ultrasonic transducer for a predetermined time when motion is detected.

16. The deterrent device of claim 10, wherein an ultrasonic burst is continuously emitted from the ultrasonic transducer for as long as motion is detected.

17. A deterrent device comprising:
an ultrasonic transducer;
a frequency adjusting component for selecting a frequency for the ultrasonic transducer;
a motion detection component for activating the ultrasonic transducer; and
wherein the deterrent device is powered by alternating current.

18. The deterrent device of claim 17, wherein the ultrasonic transducer is configured to emit an ultrasonic burst in a frequency range selectable from a plurality of predetermined frequencies.

19. The deterrent device of claim 17, wherein the ultrasonic transducer is configured to emit an ultrasonic burst in a frequency range of between approximately 35 kHz to approximately 45 kHz.

20. The deterrent device of claim 17 further comprising a battery backup.
